(19) United States
(12) Patent Application Publication
(10) Pub. No.: US 2007/0071961 A1
(43) Pub. Date: Mar. 29, 2007

(54) Exercise mat

(75) Inventor: Semi Kao, Chang-Hua Hsien (TW)

Correspondence Address: BRUCE H. TROXELL, SUITE 1404, 5205 LEESBURG PIKE, FALLS CHURCH, VA, 22041, US

(73) Assignee: Shiun Jiug Industrial Co., Ltd.

(21) Appl. No.: 11/234,165

(22) Filed: Sep. 26, 2005

(51) Int. Cl. B32B 3/26; B32B 3/00

(52) U.S. Cl. 428/304.4; 428/316.6

(57) ABSTRACT

An exercise mat includes a foaming layer and a fabric layer. The fabric layer has pores, and the foaming layer has protrusions extruded out of the fabric layer via the pores. The exercise mat of the present invention can be printed with patterns or characters on the fabric layer, and the protrusions of the foaming layer provides a well skidproof capacity.

### BACKGROUND. OF THE INVENTION

1. Field of the Invention

The present invention relates generally to a sport good, and more particularly to an exercise mat.

2. Description of the Related Art

Conventional exercise mats are made of foaming material that is hard to print patterns or characters on a surface thereof. Some conventional exercise mats are attached with a fabric thereon, such that patterns or characters can be printed on the fabric. But fabric has a poor capacity in skidproof that makes people has problem to exercise on the mat.

### SUMMARY OF THE INVENTION

The primary objective of the present invention is to provide an exercise mat, which can be printed with patterns or characters thereon and has a well skidproof property also.

According to the objective of the present invention, an exercise mat includes a foaming layer and a fabric layer. The fabric layer has pores, and the foaming layer has protrusions extruded out of the fabric layer via the pores.

### BRIEF DESCRIPTION OF THE DRAWINGS

FIG. 1 is a perspective view of a preferred embodiment of the present invention, and

FIG. 2 is a sectional view of the preferred embodiment of the present invention.

### DETAILED DESCRIPTION OF THE INVENTION

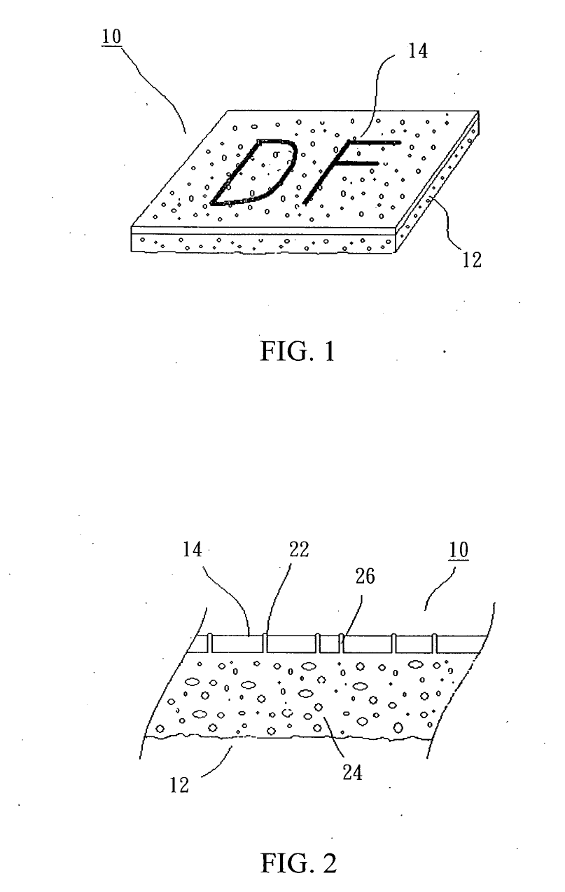

As shown in FIG. 1 and FIG. 2, an exercise mat 10 of the preferred embodiment of the present invention is consisted of a foaming layer 12 and a fabric layer 14. The fabric layer 14 is a fabric with pores 22, such as mesh fabric. To attach the fabric layer 14 on the foaming layer 12, the fabric layer 14 is rested on an unfoamed foaming material with a well skidproof property, such as rubber, styrene butadiene rubber (SBR), polyvinyl chloride (PVC), polypropylene (PP), polyurethane (PU) or ethylene vinyl acetate (EVA), and then is vulcanized to form the foaming material to tile foaming layer 12 and to bond the fabric layer 14 on tile foaming layer 12 firmly. The foaming material is extruded out of the fabric layer 14 via the pores 22 in vulcanization, such that the foaming layer 12 has a board portion 24 tinder the fabric layer 14 and protrusions 26 on the fabric layer 14. We can print patterns and characters on the fabric layer 14. Tile patterns and characters can be printed on the fabric layer 14 before vulcanization or after vulcanization.

The exercise mat 10 of the present invention may be used for Yuga practice. The exercise mat 10 of the present invention has the fabric layer 14 to print patterns and characters thereon and the protrusions 24 of the foaming layer 14 to provide a well skidproof capacity.

It has to be mentioned that the fabric layer can be any type of fabric, and the protrusions may has many shapes. In other words, the fabric layer is a porous member to print patterns and characters thereon and to expose the protrusions for spidproof

What is claimed is:

1. An exercise mat, comprising:
a foaming layer having a board portion and protrusions on the board portion; and
a fabric layer attached on the board portion of the foaming layer, wherein the fabric layer has pores, and the protrusions are exposed via the pores.

2. The exercise mat as defined in claim 1, wherein the fabric layer is printed with patterns or characters.

3. The exercise mat as defined in claim 1, wherein the fabric layer and the foaming layer are bonded together by vulcanization.

4. The exercise mat as defined in claim 2, wherein the fabric layer is printed with patterns or characters after vulcanization of the foaming layer.

5. The exercise mat as defined in claim 3, wherein the fabric layer is printed with patterns or characters after vulcanization of the foaming layer.

6. The exercise mat as defined in claim 2, wherein the fabric layer is printed with patterns or characters before vulcanization of the foaming layer.

7. The exercise mat as defined in claim 3, wherein the fabric layer is printed with patterns or characters before vulcanization of the foaming layer.

8. The exercise mat as defined in claim 1, wherein the protrusions are post-like members.

9. The exercise mat as defined in claim 1, wherein the fabric layer is a mesh fabric.
